(19) United States
(12) Patent Application Publication
(10) Pub. No.: US 2006/0002327 A1
(43) Pub. Date: Jan. 5, 2006

(54) Communication method, network element, and system including at least two network elements each having at least one endpoint for transmitting or receiving traffic information

(75) Inventors: Juha Kallio, Helsinki (FI); Esa Salo, Salinkaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/948,689

(22) Filed: Sep. 24, 2004

(30) Foreign Application Priority Data
Jun. 30, 2004 (EP) 04015323.1

(51) Int. Cl. H04Q 7/00

(52) U.S. Cl. 370/328

(57) ABSTRACT

A method, network element, and communication system relates to at least two network elements, each having at least one endpoint for transmitting or receiving traffic information to or from another network element. At least one of the network elements includes at least one storage which stores information on the traffic-information-receiving availability of at least one endpoint of at least one other network element. The at least one storage stores IP addresses of the endpoints of the other network elements, and, associated with each IP address, the information on the traffic-information-receiving availability thereof. Each endpoint has an individual storage which is updated on a regular or irregular basis. The endpoints can be signalling units such as SIP-T/I endpoints. The communication can be based on Session Initiation Protocol, or SIP.

### FIELD OF THE INVENTION

The invention relates to a method, system, network, and entity for providing status functionality, and provides supervision of availability of entities even in case when no connections exist between network elements.

### BACKGROUND OF THE INVENTION

Link status functionality is provided in circuit switched networks since decades. A problem is that no similar kind of link status functionality is implemented in packet switched networks where unreliable signalling protocols like Session Initiation Protocol, SIP, are used between the nodes.

Presently new type of products such as Mobile Switching Center Servers, MSC Servers, and Media Gateways, MGWs, as well as products called “Soft switches” for fixed networks are developed. Such products are suitable e.g. for Next Generation Networks, NGNs, which may combine both mobile and fixed networks.

Such products require use of IP based transmission for both signalling and user traffic. Session Initiation Protocol, SIP, has been chosen to be part of NGN evolution in order to provide capabilities to establish connections between SIP User Agents, UAs, as well as between soft-switches, which also MSC Servers can understood. Between these soft-switches, due the different nature of requirements, usually SIP for Telephones, SIP-T, is used instead of regular SIP.

A difference between SIP-T and regular SIP is that SIP-T tunnels the ISDN User Part (ISUP) messages transparently. A purpose of SIP messages, when also ISUP messages are present, is to enable use of SIP-framework to route ISUP messages as well as transport Session Description Protocol, SDP, in order to establish Real Time Protocol, RTP, connections for actual voice, circuit switched data or facsimile traffic.

SIP-T has been originally specified by IETF, and has gained RFC status. Despite the fact that RFC status will enable certain level of safety when building interoperable solution, also ITU-T decided to specify additional recommendations in order to achieve international level recommendation which define how SIP-T signalling information is mapped to the ISUP or Bearer Independent Call Control (similar to ISUP) signalling information, also known as SIP-I (SIP ISUP mapping). SIP-T/I means SIP-T with SIP ISUP mapping, SIP-I, of the SIP-T signalling information.

Presently there is no possibility for endpoints to monitor or supervise other endpoints such as peer endpoints like peer SIP-T/I endpoints when there is no active session such as a SIP-T/I session ongoing and a transport using an unreliable protocol, such as User Datagram Protocol, UDP, type of transport, is used. This situation is due e.g. to the basic nature of SIP-T/I, which does not use any signalling link type of concept between peer endpoints when UDP is used. In regular MTP3 or M3UA/SCTP based connections, underlying MTP2 or SCTP layer will handle the supervision of signalling connection. Thus, in those cases, there it is possible to prevent use of such signalling connections (peer entities) if signalling connection is found out to be faulty.

In case of SIP-T/I, which uses UDP, no similar connection exists between end points. An entity such as MSC Server is unable to know or learn beforehand what is the status of the signalling unit and SIP application process of the peer network element without sending INVITE to the network. Further, it is not possible for an entity to supervise or detect, before sending a message such as an INVITE message to peer node, whether or not the end point actually exists. SIP is a rather unreliable protocol for use as a signalling transport and in case no answer is received to a call setup message (such as INVITE), SIP tries to retransmit the message several times before a report is sent to call control (CC) and the call can then be re-routed.

### SUMMARY OF THE INVENTION

The invention provides a method, system, and a network element as defined in the claims.

The invention proposes a method, and a communication system including at least two network elements each having at least one endpoint for transmitting or receiving traffic information to or from another network element. At least one of the network elements comprises at least one storage which stores information on the traffic-information-receiving availability of the at least one endpoint of at least one other network element.

Preferably, the at least one storage is adapted to store an IP address of the at least one endpoint of at least one other network element, and the information on the traffic-information-receiving availability associated with each IP address. Preferably, each endpoint has an individual storage.

The invention provides solutions which allow endpoints to monitor or supervise other endpoints, in particular peer endpoints such as peer SIP-T endpoints, also in cases when there is no active session such as SIP-T session ongoing and an unreliable transport protocol providing no receipt acknowledgment or other type of receipt confirmation, such as an UDP type of transport protocol, is used.

The invention proposes, according to one of its aspects, to store availability information such as SIP-specific status information to DNS resolver cache storages of servers such as MSC Servers that are maintained by signalling unit's SIP process. This status information is maintained regularly by SIP process that will continuously circulate the cache, send OPTIONS message to each peer IP address and according to received replies (if any) also update the information in the DNS cache. All IP addresses in the cache are tried despite their actual status (such as unavailable/available).

The invention provides, among others, an advantageous mechanism for avoiding unsuccessful session establishments such as SIP-T session establishments towards an unavailable peer entity. Faster session set-up times as well as more resilient behaviour at network level are provided.

The invention is preferably used in mobile and fixed networks such as Next Generation Networks (NGN) environment where products such as MSC Server, MGWs and “Soft switches” are introduced.

The invention does not require any changes in SIP and can be implemented as an internal solution within an entity such as an MSC Server.

The invention optimizes and reduces call setup delays. There is no necessity e.g. of retransmitting a call setup message (INVITE) several times before an entity is reported to call control (CC) as unavailable and the call is re-routed.

According to the invention, it is possible to re-route a call attempt without sending INVITE to the peer network element. This enables faster session set-up times as well as more resilient behaviour at network level. Also it is possible to implement alarm or notification, which is provided by using Fault Management (FM) framework of MSC Server from failures that are detected this way.

In accordance with the invention, there is provided a communication method and system, including at least two network elements each having at least one endpoint for communicating with another network element. At least one of the network elements comprises at least one storage which stores information on the communication availability of the at least one endpoint of at least one other network element.

The at least one storage is preferably adapted to store an IP address of the at least one endpoint of at least one other network element, and the information on the communication availability associated with each IP address. Each endpoint preferably has an individual storage. The network elements may be Mobile Switching Center, MSC, Servers. The endpoints preferably are signalling units such as SIP-T/I endpoints.

The network elements are preferably adapted to communicate based on Session Initiation Protocol, SIP.

At least one, or some or all, of the network elements is preferably adapted to transmit a status inquiry to at least one other network element and to check receipt, from the at least one of the other network element, of status information indicating communication availability of at least one endpoint of the at least one other network element. This check allows to determine the communication availability of the at least one endpoint of the at least one other network element. The inquiring network element is preferably adapted to store the information on the determined communication availability in the storage. The transmitted status inquiry preferably is or comprises a SIP OPTIONS request.

The communication availability can be determined to be “no communication availability” if no response is received to the status inquiry.

A Domain Name Server, DNS, may be provided for translating Domain Names to IP addresses.

Preferably at least one of the network elements is adapted to perform an enquiry to this server. The DNS server is preferably adapted to return, to the requesting network element, at least one IP address of at least one endpoint of at least one other network element, the IP address being stored into the at least one storage.

The DNS server may also be adapted to return, to the requesting network element, a list of IP addresses of endpoints having communication availability, the list being stored into the at least one storage.

The storage is preferably configured to maintain the stored status information indicating the communication availability of an endpoint also when the IP address of the endpoint changes.

The DNS server may preferably be adapted to return the list of IP addresses of endpoints having communication availability, together with Time-To-Live, TTL, values, the TTL values being stored into the at least one storage.

IP addresses can be dynamic information, hence IP address of certain endpoints (such as SIP-T endpoint of other network elements) can change. However, endpoint names are static information and hence a new IP address of that endpoint can be resolved from DNS server.

According to the above features, it is possible to keep or maintain the old status information of the communication availability of an endpoint even if the IP address of that endpoint should change or has changed. The at least one storage preferably stores both, IP address and communication availability status, of each endpoint. IP address can change and a new IP address can be inquired from the external DNS server (for instance after TTL expires). New IP address replaces the old one in the storage but the storage still continues to store, for the new IP address, the communication availability status information of the previous IP address.

Preferably, before establishing a communication with another end point, the availability of this end point is first checked from the storage.

If an end point is marked not available for communication in the storage, an alternative end point is preferably chosen for establishing the communication.

The invention also provides a network element being adapted to communicate with another network element, having at least one endpoint for communicating with the another network element, comprising at least one storage which stores information on the communication availability of at least one endpoint of the another network element.

### BRIEF DESCRIPTION OF THE DRAWINGS

FIG. 1 shows an example of an IP based system,

FIG. 2 illustrates an example of a message flow in the system shown in FIG. 1, and

FIGS. 3 to 5 illustrate embodiments of a system and of message flows of methods in accordance with the present invention.

### DETAILED DESCRIPTION OF EMBODIMENTS OF THE INVENTION

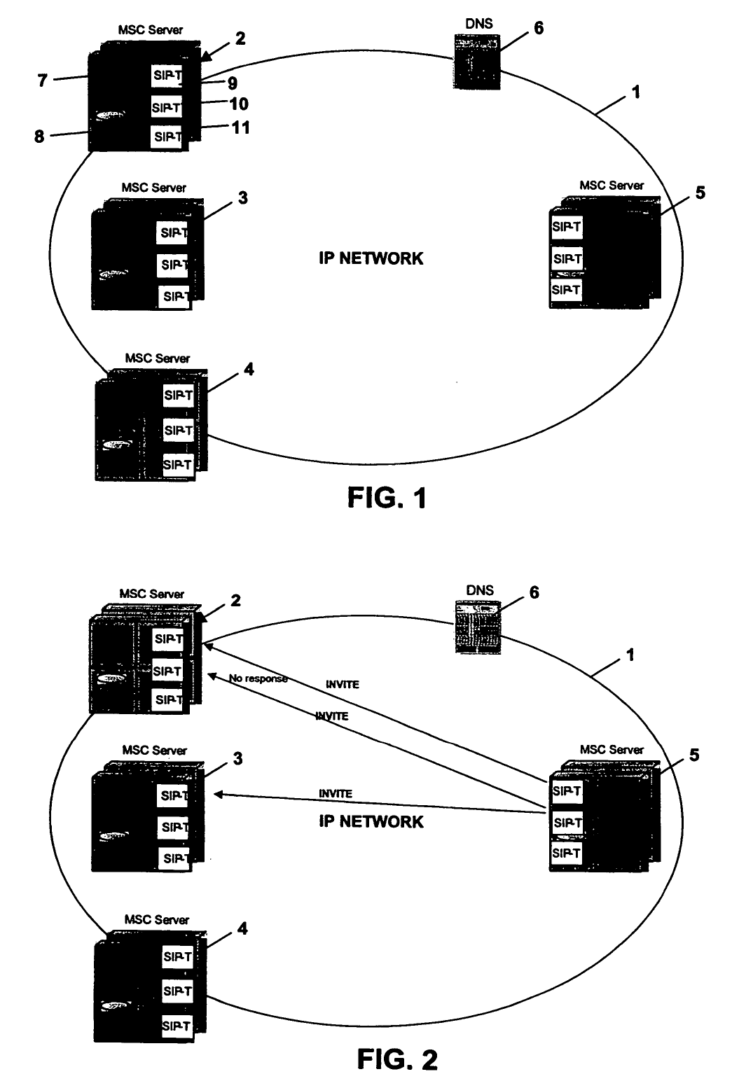

FIG. 1 represents an embodiment of an environment in which the invention can be applied. A network 1 which preferably is an IP, Internet Protocol, network, comprises the structural components and functionality for handling message flows, traffic and signalling transport for calls or any other type of connections. The network 1 includes, as shown in the drawings, several servers 2 to 5 which are implemented, in the present embodiment, as Mobile Switching Center Servers, MSC servers. etc. According to the embodiments shown in the drawings, each server 2 to 5 is structured in the same manner. Each server 2 to 5 includes a Mobile Switching Center, MSC, 7. Further, each server 2 to 5 may comprise a Visitor Location Register, VLR, 8, and one or more Service Switching Points, SSP. However, VLR 8 and SSPs may also be omitted, or may be provided in or by other type of servers than MSC servers. Each server 2 to 5 further comprises one or more endpoints 9 to 11 which each have an own IP address, and may form part of the SSP section. According to the shown embodiments, three endpoints 9 to 11 are provided in each server 2 to 5, which endpoints 9 to 11 are implemented as SIP endpoints, preferably SIP-T endpoints, and represent signalling units.

The IP network 1 further includes, or has access to, a Domain Name System, DNS, or server 6 for translating Domain Names to IP addresses.

The described embodiments of the invention are able to implement so called idle mode supervision of endpoints configured to be communicating with each other. The endpoints such as the endpoints 9 to 11 may be SIP, SIP-T or SIP-T/I endpoints, or endpoints of other type, that have been configured to be communicating between each other.

The embodiments shown in the drawings illustrate SIP-T/I interfaces. However, the invention can also be applied to other types of interfaces such as regular SIP interfaces, normally used between SIP User Agent, UA, and proxies such as SIP proxies.

The embodiments allow an interface such as a SIP-T/I interface to behave in the same way as an SS7 Network-Network Interface (NNI) where status of signalling connection is known.

In summary, aspects of the invention include one or more of the following features in isolated form or in any arbitrary combination.

One or more of the peer network elements 2 to 5 use a protocol, preferably SIP-T/I to establish circuit switched voice, data or facsimile sessions between each other. At least one, preferably some or all, of the peer network elements 2 to 5 have internal configuration data, which contains the logical Fully Qualified Domain Name (FQDN) of peer entity. This information is stored at one or more places in the routing hierarchy. The FQDN information may be stored in circuit group (CGR) level data. In case the same network element has more than one peer network element, e.g. SIP-T/I peer network element, then more than one circuit group is provided.

In case an outgoing session needs to be established towards a peer network element, the SIP-T/I process in the originating network element will process a DNS query to the Domain Name System, DNS, 6 in order to retrieve a list of candidate IP addresses (of the peer network element) from which one suitable IP address is selected for the session. In an MSC Server 2 to 6, this procedure may also be implemented in the following manner. At first, the MSC Server 2, 3, 4, or 5 will try to look from a local DNS cache storage 20 (stored in the server 2 to 5 or in each signalling unit thereof) whether there are any IP addresses available. In case DNS cache is empty (for instance, Time-To-Live, TTL, has expired for addresses or the signalling unit has just been started and no DNS enquiry has yet been done), then a DNS enquiry towards the external DNS server 6 will be carried out. Otherwise, the SIP process of the MSC Server 2, 3, 4, or 5 will use its internal or a local cache storage 20, if possible. In addition to this, also a round-robin mechanism for the DNS cache storage 20 can be implemented in order to share load between multiple IP addresses under the same logical FQDN.

According to an aspect of the invention, a mechanism is provided for avoiding unwanted SIP-T/I session establishment trials towards an unavailable peer entity.

According to the embodiments of the present invention, the servers such as the MSC Servers 2 to 5 can know beforehand what is the status of signalling units and SIP application processes of the peer network element or elements, without sending a message such as an INVITE message to the network. This way it is possible to optimise MSC Server's functionality in outgoing sessions so that the server 2 to 5 avoids addressing of unavailable entities not available for traffic, and immediately knows, and initiates, to re-route a session attempt via another server.

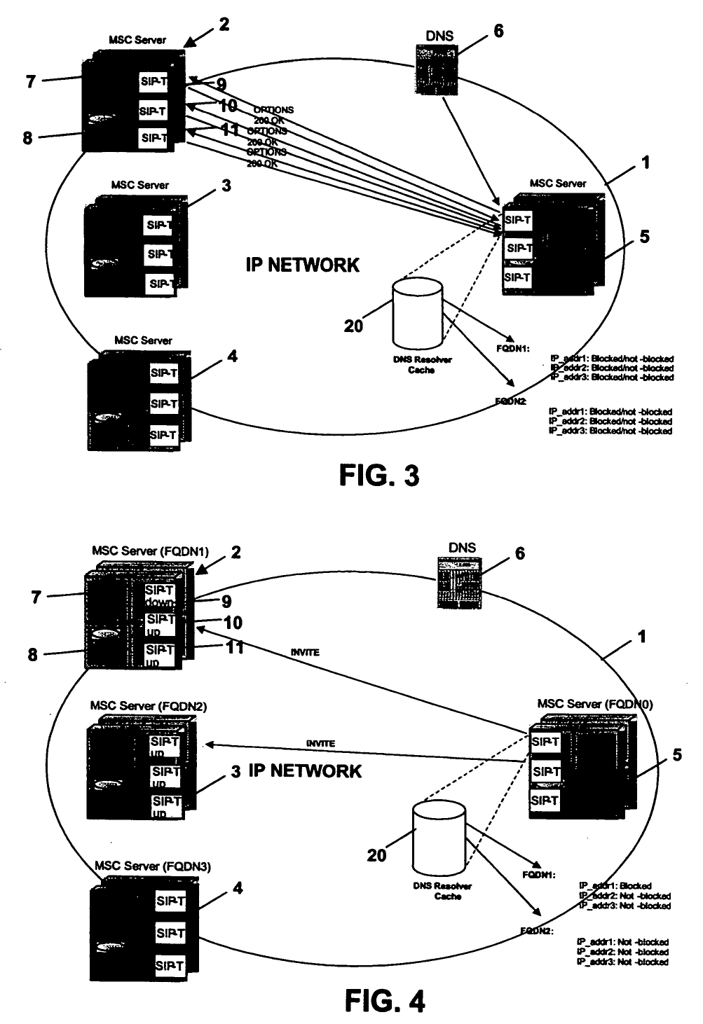

FIG. 2 represents, for comparison purpose, at network level a situation when functionalities described in the present specification are not used and originating SIP-T sessions from the MSC Server 5 to server 2 will eventually fail, in case signalling units 9 to 11 of the peer network element 2 are not available for SIP traffic. Without implementing the invention, MSC Server 5 would need to send one or more INVITE messages, as shown, towards resolved IP addresses and possibly, if no answer is received (100 Trying message) to the INVITE message, re-attempt sending INVITE messages for a predefined number of times before the session is routed towards another network element such as server 3.

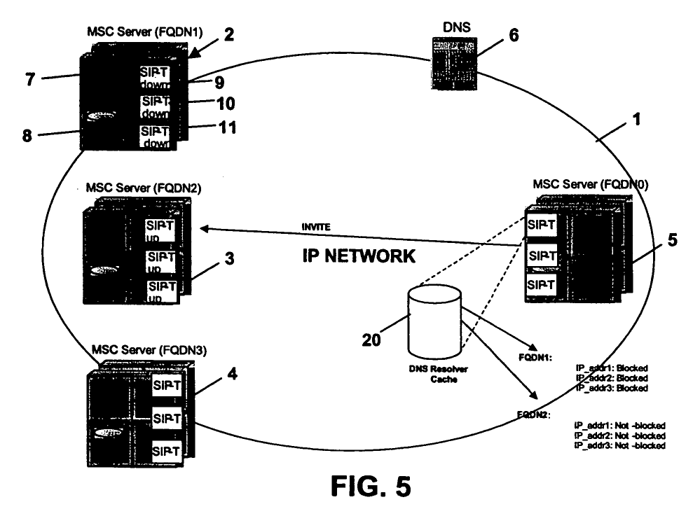

FIG. 3 shows an embodiment which represents at network level the situation when functionalities according to an embodiment of the invention are provided and used. The elements 1 to 11 shown in FIG. 3, as well as in FIGS. 4, 5, correspond to the elements 1 to 11 already described above with regard to FIG. 1, and are additionally equipped with the functions and features described below.

As shown in FIG. 3, at least one cache storage 20 is provided which serves as DNS resolver cache. Preferably each Server such as the MSC Servers 2 to 5 is equipped with an own storage 20, or at least has access to such a storage 20. In a preferred embodiment, each signalling unit such as units 9, 10, 11 of the servers 2 to 5 has an individual cache storage 20, that is a DNS resolver cache. The or each storage 20 stores actual information on availability of endpoints for session handling.

FIG. 3 shows an example where the cache storage 20 is assigned, as illustrated by broken lines, to the upper signalling unit SIP-T of the three signalling units of the server 5. The other signalling units of server 5 are equipped with similar storages, or have at least access to the shown storage 20.

The content and organization of cache storage 20, that is the listing of the stored information within storage 20, is partly shown, see arrows and inscriptions, at the right side of the storage 20.

The information on communication availability, that is availability of the endpoints for session handling or communication, may be sent as, and/or detected by, idle mode signalling traffic such as SIP-T/I signalling traffic between endpoints such as SIP-T/I end points. The invention reduces the amount of sending of unwanted or unsuccessful messages such as re-INVITE messages.

The communication availability (up/down, meaning reachable/unreachable) of each IP address is stored in local DNS resolver's cache 20 in each signalling unit, and will be kept up to date by polling the other peer elements 2 to 5, that is by sending status inquiry or checking messages to the other elements 2 to 5. The polling may be done by sending, on a regular or irregular basis, an appropriate message such as an OPTIONS message to each of the other peer elements, and to each IP address thereof. The message such as OPTIONS, will be answered by the addressed peer element in the usual manner, in case everything is alright, that is the peer element and the addressed IP address are available as an endpoint in case of intended traffic transmission. As an example, the peer element may answer by returning an 200 OK message.

The same checking procedure is done from all elements 2 to 5 to all other elements 2 to 5 and towards all possible IP addresses that particular signalling unit of the querying server 2 to 5 has connectivity to (FQDN).

The storage 20 thus stores, possibly in addition to the usual resolver data such as correspondence between IP addresses and Internet names, information on the availability or blocking status of the respective IP addresses based on the response/lack of response received to the inquiry messages such as the OPTION messages. As an example, the storage 20 stores, for each FQDN of the respective servers 2 to 5, e.g. for FQDN1 of server 2, FQDN2 of server 3, FQDN3 of server 4, etc., the status of all connectivity-providing IP addresses of that respective server. As an example, storage 20 stores, for server 2, under the name FQDN1 of that server 2, IP_addr1 of unit 9: Blocked/not blocked; IP_addr 2 of unit 10: Blocked/not blocked; and IP_addr3 of unit 11: Blocked/not blocked. The storage 20 further stores, for all other servers under their respective names, the respective information for all IP addresses thereof. That is, as shown in FIGS. 3 to 5 as an example, for server 3, that is FQDN2, the respective information Blocked/not blocked is stored for all its IP addresses IP_addr1; IP_addr 2; and IP_addr3.

At appropriate timing, for instance after Time-to-Live, TTL, expiry or if a unit such as one of the servers 2 to 5 restarts, the DNS server 6 provides a new set of IP addresses to the local caches 20 of the signalling units of the respective servers 2 to 5.

The respective cache storages 20 will be updated accordingly but information regarding blocked/not blocked status is preferably maintained from the previous list of addresses.

FIG. 4 represents the case of handling a call or connection from the point of view of an originating server 5 when only one or a few of signalling units SIP-T located in another peer network element 2 to be addressed are down. The reason for this can be e.g. that these signalling units being down have been restarted or taken out-of-use in its peer network element. According to FIG. 4, the upper SIP-T signalling unit 9 of the upper MSC server 2 is down, that is out of function and unreachable. The other signalling units 10, 11 of server 2, and those of server 3 being stored under the name FQDN2, are “up”, that means function properly.

The MSC Server 5 (FQDN0) as immediately originating server of this example will know based on its DNS resolver cache data stored in its storage 20 which IP addresses are alive in the system. In this example, assuming IP_Addr1 has been determined as primary peer element and IP_Addr2 as alternative peer element for the connection set up in question, the server 5 trying to connect to server 2, directly skips the IP_Addr1 of unit 9, being marked as blocked or down, and selects the alternative IP_Addr2 of unit 10 of server 2 which is marked as not blocked, that is marked as alive or working.

In case that, for some reason, one or more selected IP addresses marked as not-blocked are not able to process a received connection set-up message such as INVITE, then this session will be rerouted, after several unsuccessful trials, to another FQDN. This function may be in accordance with existing behaviour in servers such as MSC Servers.

FIG. 5 represents a case where a connection such as a call is originating from server 5 when all signalling units 9 to 11 located in peer network element 2 are down, that is blocked. The reason can be e.g. that IP connections to the whole site are unavailable. Assuming server 2 has been determined as a primary peer element and server 3 as alternative peer element for the call.

In this case the server 5 skips the whole server 2, that is the FQDN of this network element NE, and immediately re-routes the session to an alternative server element such as to server 3, after checking the availability of at least one of the IP addresses thereof.

According to embodiments of the invention, such as described above, at each network element (such as server 5), which is responsible of originating sessions such as SIP-T/I sessions, the state information of all possible addressable IP addresses/hosts is maintained.

In the network elements 2 to 5, the configuration is the following. Each signalling unit 9 to 11 has one logical IP address that is possible to maintain even in case of switchover (N+1 redundancy of signalling unit). This logical IP address is typically (in SIP-T/I configuration) configured into DNS system so that all available signalling units of a server and their logical IP addresses are handled via single logical FQDN (e.g. mssl.nokia.com). Each peer MSC Server which, via its signalling unit, originates SIP sessions towards this particular FQDN will select the IP addresses of the peer signalling units by using round robin scheme. This is a way that at network level a load sharing between all available signalling units is handled in terminating side.

Each signalling unit in the server has an internal DNS resolver cache 20, which is used to store results from external DNS enquiry. The content of this DNS resolver cache 20 may be limited to hold a certain amount of IP addresses under one FQDN. Also the number of FQDN's may be limited.

According to embodiments of the invention as described above, status information, in particular SIP-specific status information, is introduced to DNS resolver cache 20 that is maintained by signalling unit's SIP process. This status information is maintained regularly e.g. by SIP process that will continuously circulate the cache, send OPTIONS message to each peer IP address and according to a received reply (if any) also update the information in DNS cache. All IP addresses in cache are tried during this maintenance process, despite the status they have (unavailable/available).

In case a peer SIP process in a peer signalling unit does not reply to the OPTIONS message by returning a proper 200 OK message, then after pre-defined number of attempts the SIP process of the polling server will mark the non-replying peer signalling unit as “unavailable” in its DNS resolver cache storage 20. Any intended outgoing sessions from this signalling unit, to which the storage 20 is assigned, towards an “unavailable” IP address will be prevented and the SIP process of this signalling unit will proceed to select some other “available” IP address found from its cache 20 belonging to a particular FQDN, if any.

In case later supervision attempts by using OPTIONS message sent by the polling server to an IP address of a polled server being marked as unavailable will succeed, then this IP address will be set again as “available” in the DNS resolver's cache 20 of the polling server. Further, if a signalling message, such as SIP INVITE, is received from an end point being marked as unavailable, the sending end point may be set “available” in the DNS resolver's cache 20 again.

In case all IP addresses are found to be “unavailable” in MSC Server processing outgoing SIP-T/I session, then session establishment needs to be cleared backwards into End of Selection (EOS) analysis phase that will result in selection of another route towards another MSC Server. This may be existing behaviour of MSC Server and may be re-used in order to complete the call by using an alternative route.

Each DNS enquiry from or to the external DNS server 6 will together with the list of available IP addresses also provide a so called Time-To-Live (TTL) value to requesting signalling unit. This list and TTL information are stored into DNS resolver's cache 20. When SIP process or any other process which uses the services of DNS make a DNS enquiry, at first the DNS resolver entity in the unit will query its local cache storage 20. The provision of the cache storage 20 will speed up the DNS enquiry process and decrease the traffic from and to external DNS servers. In order to avoid problems caused by use of the local cache storage 20 in the signalling units if information in external DNS server changes, DNS enquiries from signalling units are done on a regular or irregular basis in order to refresh correct information to local caches.

The TTL identifies the time duration that DNS resolver caches 20 in the signalling units will keep the information stored locally. After the time indicated by TTL elapses then an external query from the server incorporating the cache storages of the signalling units to the DNS server 6 will be done, and the received DNS information will be stored in the cache 20.

In case TTL value for FQDN expires and IP addresses are enquired from DNS server, local DNS resolver may be implemented to remember the status that existed before the new DNS enquiry from the external DNS server 6. This implementation duplicates the amount of memory in case all IP addresses are stored before being compared to the new addresses. In an alternative embodiment of the invention, only “unavailable” IP addresses are stored over the new enquiry, which saves memory space in each signalling unit.

According to another embodiment of the invention, it is possible for an operator to see or receive information which peer IP addresses are not available for signalling traffic. This can be achieved by triggering a notification (or low level alarm) in local fault management system that identifies the peer IP address that is currently found out to be “unavailable”. Also in case whole FQDN is found out to be unavailable (all IP addresses in DNS resolver's cache 20 related to this FQDN are marked as “unavailable”), then a notification such as a higher-level alarm can be triggered. It is also possible to provide some kind of command which can be used by an operator to check which IP addresses in cache are “unavailable” and which are not.

Implementation of the invention can be done inside the DNS resolver means or function in the servers 2 to 5. This may be a platform functionality, not an application. Such a modification can be applied to other products or network elements as well.

The SIP process of the servers 2 to 5 is preferably modified in order to circulate the content of the DNS cache storage 20 so that new interfaces can “see” the content of cache storage 20, and to send supervision messages such as supervision OPTIONS message. As an alternative, a type of handler can be defined which implements these tasks continuously without affecting the other traffic handling work of SIP process.

An updating means or function such as a SIP process is preferably provided to update the DNS resolver cache storage 20 (e.g. providing a new interface) so that “unavailable”/“available” information is maintained properly.

Handlers which are responsible of actual traffic can use the DNS enquiry in a customary manner and as a result the DNS cache storage 20 can return either the IP address (selected by DNS resolver) or information that no available IP address can be found for a requested FQDN. In case DNS resolver returns no IP address to SIP process and further indicates that all addresses are unavailable, the SIP process will preferably clear call establishment backwards to the call control process (e.g. IC3) with proper clear code (such as cd_t_congestion.) which will result in an alternative routing to another route and another FQDN.

The embodiments of the invention therefore can have pre-hand knowledge of the status of peer network element's signalling units (IP addresses) before sending a message, e.g. an INVITE message.

The invention does not require any changes in SIP signalling. It is sufficient that other end points (peers) are capable to reply to availability polling requests such as SIP OPTIONS requests according to basic SIP specifications. The invention can be implemented, according to some of the embodiments, related to SIP proxy implementation.

The mechanism according to the invention can be applied not only to servers such as MSC servers but also to structures of any types such as for example SIP proxy peers.

1. A communication system comprising:
a plurality of network elements including a network element having at least one endpoint for communicating with another network element, wherein said network element comprises at least one storage to store information on communication availability of another at least one endpoint of at least one other network element of the plurality of network elements.

2. System according to claim 1, wherein the at least one storage is configured to store an IP address of the another at least one endpoint of the at least one other network element, and the information on the communication availability associated with each IP address.

3. System according to claim 1, wherein said at least one endpoint has an individual storage.

4. System according to claim 1, wherein the plurality of network elements comprises mobile switching center (MSC) servers.

5. System according to claim 1, wherein the at least one endpoint comprises a signalling unit.

6. System according to claim 1, wherein the at least one endpoint comprises a SIP-T/I endpoint.

7. System according to claim 1, wherein the plurality of network elements is configured to communicate based on session initiation protocol (SIP).

8. System according to claim 1, wherein the network element is configured to transmit a status inquiry to the at least one other network element and to check receipt, from the at least one other network element, of status information indicating the communication availability of the another at least one endpoint of the at least one other network element, for determining the communication availability of the another at least one endpoint of the at least one other network element, wherein the network element is configured to store the information on the communication availability in the at least one storage.

9. System according to claim 8, wherein the status inquiry comprises a SIP OPTIONS request.

10. System according to claim 9, wherein the communication availability is determined to be a no communication availability state if no response is received to the status inquiry.

11. System according to claim 1, comprising a server for translating domain names to IP addresses.

12. System according to claim 11, wherein the network element is configured to perform an inquiry to the server, the server (is configured) to return, to the network element, at least one IP address of the at least one endpoint of the another at least one other network element, wherein the IP address is stored into the at least one storage.

13. System according to claim 1, wherein the storage is configured to maintain the information indicating the communication availability of the another at least one endpoint when an IP address of the another at least one endpoint changes.

14. A method for use in a communication system, said communication system including a plurality of network elements, each network element having at least one endpoint for communicating with another network element, the method comprising:
storing, at a network element, information on a communication availability of at least one endpoint of at least one other network element in at least one storage.

15. Method according to claim 14, wherein said storing step comprises storing in the at least one storage, IP addresses of the another at least one endpoint of the at least one other network element, and, associated with each IP address, the information on the communication availability.

16. Method according to claim 14, wherein each endpoint has an individual storage.

17. Method according to claim 14, wherein the plurality of network elements comprises mobile switching center (MSC) servers.

18. Method according to claim 14, wherein the at least one endpoint comprises a signalling unit.

19. Method according to claim 14, wherein the at least one endpoint comprises a SIP-T/I endpoint.

20. Method according to claim 14, wherein the network element is communicating with other network element using session initiation protocol.

21. Method according to claim 14, further comprising transmitting a status inquiry from the network element to at least one other network element for determining status information indicating the communication availability of the at least one endpoint of the at least one other network element, wherein the status information is stored in the at least one storage.

22. Method according to claim 21, wherein said transmitting the status inquiry comprises transmitting a SIP OPTIONS request.

23. Method according to claim 22, further comprising determining the communication availability to be a no communication availability state if no response is received to the status inquiry.

24. Method according to claim 14, further comprising the step of establishing communication with another endpoint, wherein an availability of the another endpoint is first checked from the at least one storage.

25. Method according to claim 24, further comprising, if the endpoint is marked not available for communication in the at least one storage, choosing an alternative endpoint for establishing the communication.

26. Method according to claim 14, further comprising performing an inquiry by the network element to a server for translating domain names to IP addresses, the server returning, to the network element, at least one IP address of the at least one endpoint of the at least one other network element, wherein the at least one IP address is stored into the at least one storage.

27. Method according to claim 14, further comprising maintaining in the at least one storage the status information indicating the communication availability of the at least one endpoint also when an IP address of the at least one endpoint changes.

28. A network element to communicate with at least one endpoint of another network element, comprising:
at least one storage to store information on communication availability of said at least one endpoint of said another network element.

29. Network element according to claim 28, wherein the at least one storage is configured to store IP addresses of the at least one endpoint of the another network element, and, associated with each stored IP address, the information on the communication availability of said stored IP address.

30. Network element according to claim 28, comprising an individual storage for each of its endpoints.

31. Network element according to claim 28, wherein the network element comprises a mobile switching center server.

32. Network element according to claim 28, wherein the at least one endpoint comprises a signalling unit.

33. Network element according to claim 28, wherein the at least one endpoint comprises a SIP-T/I endpoint.

34. Network element according to claim 28, wherein the network element is configured to communicate with another network element using session initiation protocol.

35. Network element according to claim 28, wherein the network element is configured to transmit a status inquiry to the another network element, and to check receipt, from the another network element, of status information indicating said communication availability of the at least one endpoint of the another network element, for determining the communication availability of the at least one endpoint of the another network element, wherein the network element is configured to store the information on the communication availability in the at least one storage.

36. Network element according to claim 35, wherein the status inquiry comprises a SIP OPTIONS request.

37. Network element according to claim 34, wherein the communication availability is determined to be a no communication availability state if no response is received to the status inquiry.

38. Network element according to claim 28, comprising means for communicating with a domain name server to resolve an IP address of at least one endpoint.

39. Network element according to claim 28, comprising means for maintaining in the at least one storage said information on communication availability of at least one endpoint also when the IP address of the endpoint changes.

40. Network element according to claim 28, comprising means for sending a status inquiry to resolve communication availability of an endpoint;
means for receiving a response to the inquiry;
means for determining the communication availability of the endpoint based on the response; and
means for storing the determined communication availability in the at least one storage together with the identifier of the endpoint.

41. Network element according to claim 40, wherein the means for determining the communication availability are configured to determine a “no communication availability” state if no response is received to the status inquiry.

42. Network element according to claim 40, wherein the means for sending a status inquiry are configures to send a SIP OPTIONS request.

43. Network element according to claim 40, further comprising means for checking communication availability of an endpoint in the storage; and
means for establishing communication to the endpoint, wherein if the communication availability of the endpoint is a “no communication availability” state in the storage, means for establishing communication are configured to choose an alternative endpoint based on predefined rules.

44. A communication system comprising:
a plurality of network elements including a network element having at least one endpoint for communicating with another network element; and
storing means for storing information on communication availability;
wherein said network element accesses said storing means for said information on the communication availability of an endpoint of another network element.
